(19) United States
(12) Patent Application Publication
(10) Pub. No.: US 2007/0195116 A1
(43) Pub. Date: Aug. 23, 2007

(54) Inkjet printer head, inkjet printing system having the same, and control method thereof

(75) Inventors: Jong-beom Kim, Yongin-si (KR); Jae-woo Chung, Yongin-si (KR); Yong-soo Lee, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/634,870

(22) Filed: Dec. 7, 2006

(30) Foreign Application Priority Data
Feb. 20, 2006 (KR) 2006-16296

(51) Int. Cl. B41J 29/38

(52) U.S. Cl. 347/10

(57) ABSTRACT

An inkjet printing system to control actuators in real time. The inkjet printing system includes a waveform generator to supply electric power in the form of a predetermined wave, at least one actuator to change a pressure in an ink chamber according to the electric power from the waveform generator, at least one sensing unit to continuously detect and output a voltage value for the voltage outputted by the actuator, and a controller to calculate an inductive voltage value induced by a deformation of the actuator using the detected result from the sensing unit, and to adjust the waveform of the electric power supplied by the waveform generator according to the calculated inductive voltage value, thereby controlling the actuator.

### CROSS-REFERENCE TO RELATED APPLICATIONS

This application claims priority under 35 U.S.C. § 119(a) from Korean Patent Application No. 10-2006-016296, filed Feb. 20, 2006, in the Korean Intellectual Property Office, the entire disclosure of which is incorporated herein by reference.

### BACKGROUND OF THE INVENTION

1. Field of the Invention

The present general inventive concept relates to an inkjet printer head having actuators, an inkjet printing system having the inkjet printer head, and a method of controlling the inkjet printing system. More particularly, the present general inventive concept relates to an inkjet printer head capable of detecting deformation states of actuators in real time, an inkjet printing system having the inkjet printer head, capable of controlling the actuators in real time according to the detected result, and a method of controlling the inkjet printing system.

2. Description of the Related Art

With the widespread home use of computers, the popularity of peripheral devices for computers, particularly image forming apparatuses, has increased. A typical example of an image forming apparatus is a printer. The printer can be classified as a dot printer, an inkjet printer, or a laser printer according to a printing method. In recent times, the dot printer is rarely used because its operation generates a large amount of noise and has a slow printing speed. While the laser printer is advantageous because it has a high printing speed, it is too expensive for an individual user to purchase. Thus, the inkjet printer is a popular option used in many homes. The inkjet printing method is also applied to and used in other image forming apparatus besides the printer, such as, a copy machine, a facsimile, a multi-function machine and the like.

Generally, the image forming apparatus for the inkjet printing method, referred as an inkjet printing system below, includes a printer head. A plurality of nozzles are disposed in the printer head, and each of the nozzles ejects ink droplets onto a sheet of paper conveyed below the printer head to print a desired image thereon.

To eject the ink droplets, it is necessary to change pressures in ink chambers, which are filled with ink. One method of changing the pressure in the ink chambers, is to increase temperatures in the ink chambers through heat generating elements respectively disposed in the ink chambers. Another such method of deforming a space in the ink chambers is through the use of actuators, such as piezoelectric elements, disposed outside the ink chambers to increase the pressure in the respective ink chambers.

FIG. 1 is a view illustrating a conventional inkjet printer head. Referring to FIG. 1, the inkjet printer head includes an ink inlet channel 10, an ink chamber 20, an actuator 30, and a nozzle 40. FIG. 1 illustrates only one nozzle 40; however in effect, a plurality of nozzles are arranged in a predetermined array to carry out a desired image forming process.

Ink fills the ink chamber 20 through the ink inlet channel 10 as illustrated in FIG. 1. When the actuator 30 is supplied with a voltage, the actuator is deformed and bent in a direction of arrows. As a result of the deformation of the actuator, the ink in the ink chamber 20 is ejected through the nozzle 40.

To maintain uniform volume and speed of ink droplets ejected through the nozzle 40, the inkjet printing system generally carries out a sequential control process, which detects operations of the respective actuator 10 after the actuator 30 is driven.

In the conventional inkjet printing system, after one actuator is driven, the pressure in the corresponding ink chamber 20 is detected before the actuator 30 is driven again. This allows the driving voltage to be adjusted before the actuator is driven again. The pressure in the ink chamber is at its maximum right after the actuator is driven, and drops after a predetermined time. If it is detected that the pressure in the ink chamber has not dropped to an original state before the next time the actuator 30 is driven, a conventional inkjet system lowers the subsequent driving voltage applied to the actuator to a predetermined value. This allows for the regular adjustment of the volume and speed of the ink droplets ejected through the nozzle.

It is important to note that in the conventional inkjet printing system, the pressure in the ink chamber is detected only for a period when the actuator is not driven, that is, a period where the driving signal is not supplied to the actuator. Accordingly, it is impossible to control the actuator in real time to properly cope with external factors, such as vibrations, which can occur when the driving signal is not supplied.

### SUMMARY OF THE INVENTION

The present general inventive concept provides an inkjet printer head capable of continuously detecting deformation states of actuators.

The present general inventive concept provides an inkjet printing system having the inkjet printer head, capable of continuously detecting deformation states of actuators and controlling operations of the actuators in real time according to the detected resulted, and a control method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an inkjet printing system including a waveform generator to supply an electric power in the form of a predetermined wave, at least one actuator to change a pressure in an ink chamber according to the electric power from the waveform generator, at least one sensing unit to continuously detect and output a voltage value outputted by the actuator, and a controller to calculate an inductive voltage value induced by a deformation of the actuator using the voltage value the sensing unit, and to use the calculated inductive voltage value to adjust a waveform of the electric power supplied by the waveform generator, thereby controlling the actuator to have the same displacement.

The sensing unit may include a second capacitor connected to the actuator to form a circuit with the actuator such that the second capacitor is connected in series with a first capacitor included within the actuator, a third capacitor connected between the actuator and a ground to model a circuit such that the third capacitor is connected in parallel with the first capacitor and the second capacitor, and a fourth capacitor connected in series between the third capacitor and the ground, to output a first node voltage between the first capacitor and the second capacitor and a second node voltage between the third capacitor and the fourth capacitor.

The system may further include a calculator to calculate a difference in electric potential between the first node voltage and the second node voltage and to provide the difference to the controller.

The controller may obtain the inductive voltage value according to the difference in electric potential between the first node voltage and the second node voltage using formula 1 and formula 2:

$$\begin{matrix}{P}^{T} q = \{ {V}_{s} - ( \frac{{C}_{p}}{{C}_{p} + {C}_{1}} - \frac{{C}_{r}}{{C}_{r} + {C}_{1}} ) {V}_{c} \} * ( {C}_{p} + {C}_{1} ) \\ where & ( 1 ) \\ {V}_{p} = \frac{{P}^{T} q}{{C}_{p}} & ( 2 )\end{matrix}$$

Vₛ is the difference in electric potential between the first node voltage and the second node voltage, Cₚ is the first capacitance component, C₁ is a capacitance of the second and the fourth capacitors, Cᵣ is a capacitance of the third capacitor, V_{c} is a magnitude of the electric power, p^{T} is a row vector presenting a force of the actuator which is applied to the ink chamber, q is a column vector presenting the displacement of the actuator, and Vₚ is the inductive voltage value induced by the deformation of the actuator.

The controller may compare the inductive voltage value with a predetermined reference value, and control the waveform generator in order to reduce a magnitude of the waveform if the inductive voltage value is larger than the predetermined reference value, and to increase the magnitude of the waveform if the inductive voltage value is smaller than the predetermined reference value.

The system may further include a trigger signal producing unit to produce a trigger signal to determine a driving point of time of the actuator and to provide the produced trigger signal to the controller. In this case, the controller may drive the actuator according to the trigger signal provided from the trigger signal producing unit.

The system may further include an amplifier to amplify the waveform outputted from the waveform generator and to provide the amplified waveform to the actuator.

The actuator may be formed of piezoelectric material.

The foregoing and/or other aspects of the present general inventive concept may also be achieved by providing an inkjet printer head including at least one actuator to change a pressure in an ink chamber when an electric power in the form of a predetermined wave is applied, and at least one sensing unit to continuously detect and output a voltage value as voltage output from the actuator to control the actuator.

The sensing unit may include a second capacitor connected to the actuator to form a circuit such that the second capacitor is connected in series with a first capacitor included within the actuator, a third capacitor connected between the actuator and a ground such that the third capacitor is connected in parallel with the first capacitor and the second capacitor, and a fourth capacitor connected in series between the third capacitor and the ground, to output a first node voltage between the first capacitor and the second capacitor and a second node voltage between the third capacitor and the fourth capacitor.

The actuator may be formed of piezoelectric material.

The foregoing and/or other aspects of the present general inventive concept may also be achieved by providing a method of control of an inkjet printing system having at least one ink chamber, and at least one actuator formed of a piezoelectric material to change pressure in the ink chamber. The method may include applying an electric power to the actuator to deform the actuator, continuously detecting a voltage value output from the actuator, calculating an inductive voltage value induced by a deformation of the actuator using the detected voltage value from the sensing unit, and adjusting the waveform of the supplied electric power according to the calculated inductive voltage value to control the actuator.

The continuous detecting of the voltage value may include detecting and outputting a first node voltage and a second node voltage by using a sensing circuit. The sensing circuit may include a second capacitor connected to the actuator to form a circuit such that the second capacitor is connected in series with a first capacitor included within the actuator, a third capacitor connected between the actuator and a ground to model a circuit such that the third capacitor is connected in parallel with the first capacitor and the second capacitor, and a fourth capacitor connected in series between the third capacitor and the ground. To output a first node voltage between the first capacitor and the second capacitor and the second node voltage between the third capacitor and the fourth capacitor.

The calculating of the inductive voltage value may include calculating the difference in electric potential between the first node voltage and the second node voltage according to formula 1 and formula 2:

$$\begin{matrix}{P}^{T} q = \{ {V}_{s} - ( \frac{{C}_{p}}{{C}_{p} + {C}_{1}} - \frac{{C}_{r}}{{C}_{r} + {C}_{1}} ) {V}_{c} \} * ( {C}_{p} + {C}_{1} ) & ( 1 ) \\ {V}_{p} = \frac{{P}^{T} q}{{C}_{p}} & ( 2 )\end{matrix}$$

where Vₛ is the difference in electric potential between the first node voltage and the second node voltage, Cₚ is the first capacitance component, C₁ is a capacitance of the second and the fourth capacitors, Cᵣ is a capacitance of the third capacitor, V_{c} is a magnitude of the electric power, p^{T} is a row vector presenting a force of the actuator which is applied to the ink chamber, q is a column vector presenting the displacement of the actuator, and Vₚ is the inductive voltage value induced by the deformation of the actuator.

The adjusting of the waveform of the supplied electric power may include comparing the inductive voltage value with a predetermined reference value, reducing a magnitude of the waveform if the inductive voltage value is larger than the predetermined reference value, and increasing the magnitude of the waveform if the inductive voltage value is smaller than the predetermined reference value.

The foregoing and/or other aspects of the present general inventive concept may also be achieved by providing a waveform generator to supply an electric power, at least one actuator to change a pressure in an ink chamber to be deformed according to the electric power, a controller to control the actuator according to an inductive voltage value induced by a deformation of the actuator.

The controller controls the actuator to have a uniform displacement, and may also control the actuator to maintain uniform pressure in the ink chamber. The controller also may generate a second electric power according to the inductive value to control the actuator and may control the actuator to have the same amount of the displacement. The controller controls the actuator to eject the same amount of ink from the ink chamber according to the inductive voltage value. The controller repeats to adjust the electric power until the inductive voltage value is less than a reference.

A sensing unit to detect a voltage difference between the electric power may be applied to the actuator and a second electric power generated from the actuator.

The displacement of the actuator may include a vibration to cause a pressure change of the ink chamber.

The foregoing and/or other aspects of the present general inventive concept may also be achieved by providing a computer readable recording medium having embodied thereon a program which executes a method of determining a characteristic of an actuator to change a pressure in an ink cartridge, the method including applying an electric power to the actuator to deform the actuator, continuously detecting a voltage value as a voltage output from the actuator, calculating an inductive voltage value induced by deformation of the actuator using the detected voltage value, and adjusting a waveform of the electric power according to the calculated inductive voltage value to control the actuator.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional inkjet printer head;

FIG. 2 is a block diagram illustrating an inkjet printing system according to an embodiment of the present general inventive concept;

FIG. 3 is a view illustrating an inkjet printer head useable in an the inkjet printing system according to an embodiment of the present general inventive concept;

FIG. 4 is a block diagram illustrating an inkjet printing system according to an embodiment of the present general inventive concept; and

FIG. 5 is a flow chart illustrating a control method of the inkjet printing system according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept with respect to the figures.

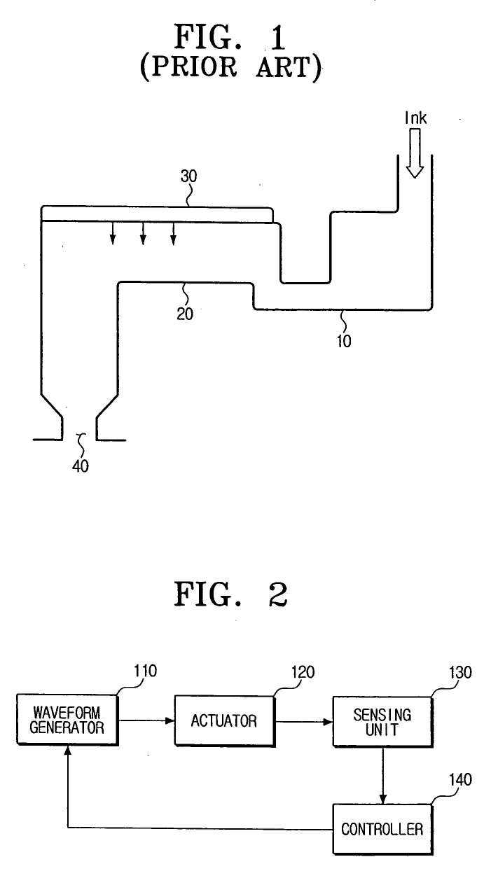

FIG. 2 is a block diagram illustrating an inkjet printing system according to an embodiment of the present general inventive concept. The inkjet printing system illustrated in FIG. 2 includes a waveform generator 110, an actuator 120, a sensing unit 130 and a controller 140.

The waveform generator 110 supplies an electric power in the form of a predetermined wave, such as a pulse wave, to the actuator 120.

The actuator 120 is formed of a piezoelectric material, and is disposed on an outside of an ink chamber. Accordingly, when the waveform generator 110 supplies the electric power to the actuator 120, the actuator oscillates to change a pressure in the ink chamber. As described with respect to FIG. 1, when the pressure in the ink chamber is changed, ink is ejected through a nozzle. The actuator 120 may have electrode layers and a vibration layer to move according to the electric power applied to the electrode layers.

The sensing unit 130 detects a value corresponding to a voltage outputted from the actuator 120. When the actuator 120 oscillates, an inductive voltage of a predetermined magnitude is induced. The oscillation of the actuator 120 is maintained for a predetermined time from when the actuator 120 is supplied with the electric power to when it is stabilized to stop. If the actuator 120 is again supplied with the electric power, the actuator starts to oscillate again. The sensing unit 130 may be a circuit connected to at least one of the electrode layers to detect the voltage.

For a period referred to as a power supplying period, the inductive voltage value induced by the oscillation of the actuator 120 is detected together with a waveform signal. When the electric power is in a form of a pulse wave, pulses having a high amplitude can be used as the electric power. Accordingly, in the conventional inkjet printing system, the deformation of the actuator cannot be accurately detected, because the detecting operation is stopped for the power supplying period, and carried out only for a non-power supplying period. That is, because the detecting operation is intermittently carried out, it is impossible to control the actuator in real time in the conventional inkjet printing system.

In contrast, the inkjet printing system of the present embodiment includes the sensing unit 130 continuously detect an output value outputted from the actuator 120, even for the power supplying period. As a result, it is possible to continuously control the actuator 120. A construction and an operation of the sensing unit 130 will be described in detail below.

The sensing unit 130 detects an output value in which the inductive voltage value induced by the deformation of the actuator 120 is added to the electric power supplied from the waveform generator 110. The controller 140 separates the inductive voltage value from the output value and controls the waveform generator 110 according to the separated inductive voltage value to adjust the waveform of the electric power. More specifically, the controller 140 compares the inductive voltage value with a predetermined reference value. If the inductive voltage value is larger than the predetermined reference value, the controller 140 reduces the magnitude of the electric power produced by the waveform generator 110, and if the inductive voltage value is smaller than the predetermined reference value the controller 140 increases the magnitude of the electric power produced by the waveform generator.

The inductive voltage value represents a degree of the deformation of the actuator 120, which indicates the pressure in the ink chamber, as an index corresponding to the pressure. A value which may be obtained by measuring and storing therein in advance can be used as the reference value the inductive voltage value, detected by the sensing unit 130 when the ink chamber has an optimum pressure.

The actuator 120 and the sensing unit 130 illustrated in FIG. 2 are disposed in an inkjet printer head. The inkjet printer head is provided with a plurality of ink chambers, each of which has the actuator 120 disposed thereto. Each actuator 120 is connected to a corresponding sensing unit 130. Therefore, one actuator 120 and one sensing unit 130 may be provided for every ink chamber.

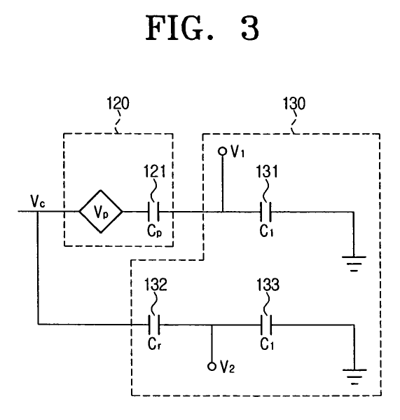

FIG. 3 is a view illustrating an inkjet printer head useable in an inkjet printing system according to an embodiment of the present general inventive concept. In the inkjet printer head illustrated in FIG. 3, only circuit structures of one actuator 120 and one sensing unit 130 are illustrated. For the sake of brevity, detailed descriptions of ink chambers, nozzles, ink inlet channel, etc. are omitted because these structures can be identical to those of a conventional inkjet printer head.

As illustrated in FIGS. 2 and 3, the sensing unit 130 is connected to a rear end of the actuator 120. The actuator 120 models a circuit with an electric power Vp and a first capacitor 121. The electric power Vp is the inductive voltage value induced by the deformation of the actuator 120 according to a power Vc as the electrical power of the waveform generator 110, and the first capacitor 121 is a first capacitance component, included in the actuator 120. In FIG. 3, a first capacitance component Cp represents a capacitance of the first capacitor 121.

The sensing unit 130 includes a second capacitor 131 connected in series to the first capacitor 121, a third capacitor 132 connected to the actuator 120 and connected in parallel to the first and the second capacitors 121 and 131, and a fourth capacitor 133 connected in series between the third capacitor 132 and the ground. The capacitance of the third and the fourth capacitors 132 and 133 are represented as Cr and C1, respectively. FIG. 3, illustrates the capacitances of the second and the fourth capacitors 131 and 133 identically as C1. Further the first, the second, the third and the fourth capacitors 121, 131, 132, 133 are connected in a shape of a bridge.

The sensing unit 130 detects a first node voltage V1 and a second node voltage V2 and outputs them to the controller 140. The controller 140 uses the difference in electric potential between the first node voltage and the second node voltage to calculate the inductive voltage value Vp induced by the deformation of the actuator 120.

The difference in electric potential between the first node voltage and the second node voltage is represented by the following mathematical formula:

$${V}_{s} = {V}_{1} - {V}_{2} = ( \frac{{C}_{p}}{{C}_{p} + {C}_{1}} - \frac{{C}_{r}}{{C}_{r} + {C}_{1}} ) {V}_{c} + \frac{{P}^{T}}{{C}_{p} + {C}_{1}} q \qquad [ Mathematical formula 1 ]$$

where Vₛ is the difference in electric potential between the first node voltage and the second node voltage, p^{T} is a row vector presenting a force of the actuator which is applied to the ink chamber, and q is a column vector presenting the displacement of the actuator.

In mathematical formula 1, the components on the left of a sign of equality (=) can be directly measured from the value detected by the sensing unit 130. Among the components on the right of the sign of equality (=), C1, Cp, and Cr are values, which are already known. Accordingly, the mathematical formula 1 can be rearranged and represented as the following mathematical formula 2.

$${P}^{T} q = \{ {V}_{s} - ( \frac{{C}_{p}}{{C}_{p} + {C}_{1}} - \frac{{C}_{r}}{{C}_{r} + {C}_{1}} ) {V}_{c} \} * ( {C}_{p} + {C}_{1} ) \qquad [ Mathematical formula 2 ]$$

The controller 140 substitutes the value obtained as a result of mathematical formula 2 into the following mathematical formula 3, to calculate the inductive voltage value Vp induced by the deformation of the actuator 120.

$${V}_{p} = \frac{{P}^{T} q}{{C}_{p}} \qquad [ Mathematical formula 3 ]$$

After the inductive voltage value Vp is calculated with the mathematical formula 3, the controller 140 compares the inductive voltage value Vp with the reference value, and thereby adjusts the waveform of the electric power of the waveform generator.

Although FIG. 3 illustrates a circuit of the sensing unit 130 to detect the first and second node voltages, the present general inventive concept is not limited thereto. The sensing unit 130 may be a circuit disposed to detect any induced power (current or voltage), the first and second node voltages, or the inductive voltage value Vp.

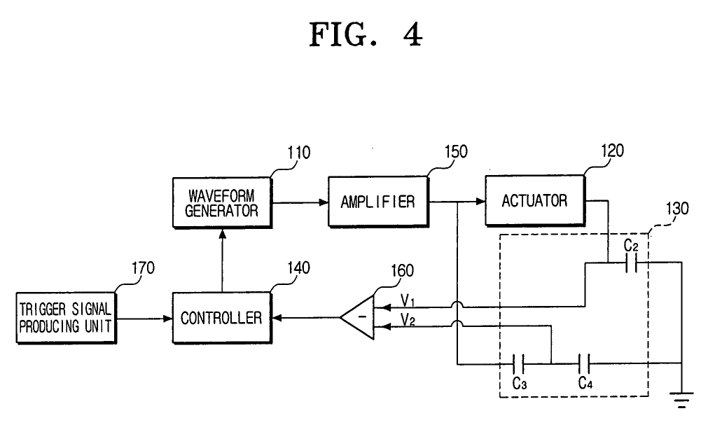

FIG. 4 is a block diagram illustrating an inkjet printing system according to an embodiment of the present general inventive concept. Referring to FIGS. 2 and 4, the inkjet printing system includes an amplifier 150, a calculator 160 and a trigger signal producing unit 170 in addition to the waveform generator 110, the actuator 120, the sensing unit 130, and the controller 140 which are illustrated in FIG. 2.

The trigger signal producing unit 170 produces a trigger signal to determine a point of time to drive the actuator 120 and provides the produced trigger signal to the controller 140. The trigger signal may be produced in the form of a pulse wave. The controller 140 directs the waveform generator 110 to output a waveform signal according the trigger signal.

The amplifier 150 amplifies the waveform signal output from the waveform generator 110 in a magnitude, which is capable of driving the actuator 120.

The waveform signal amplified by the amplifier 150 oscillates the actuator 120, so that it changes the pressure in the ink chamber to eject ink therein.

The sensing unit 130 detects an oscillation of the actuator 120 as an oscillation state of the actuator. That is, as described above, the sensing unit 130 outputs a first node voltage V1 and a second node voltage V2.

The sensing unit 130 is made up of a plurality of capacitors C2, C3 and C4, which are connected in the form of a bridge to the actuator 120. For the sake of brevity, detailed descriptions of the sensing unit 130 and a difference in electric potential between the first node voltage and the second node voltage are omitted because the construction can be identical to those listed above.

The calculator 160 calculates the difference in electric potential between the first node voltage and the second node voltage, and provides it to the controller 140. The calculator 160 may take the form of a subtractor or a comparator.

The controller 140 calculates the inductive voltage value induced by the deformation of the actuator 120 using the calculated result of the calculator 160, and controls the waveform generator 110 according to the calculated inductive voltage value. As a result, the controller 140 can control the actuator 120, so that the subsequent displacements of the actuator 120 are identical to each other so that the electric power can have the same magnitude. Particularly, since the displacements of the actuator 120 are detected even when the waveform signal is transmitted to the actuator 120, the actuator 120 can be controlled in real time according to the detected results.

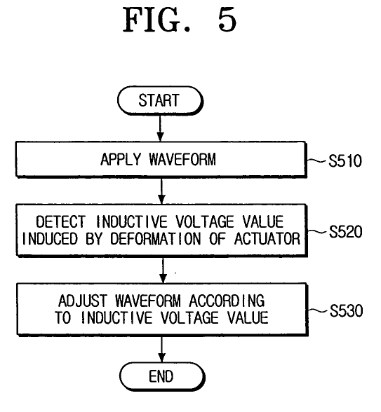

FIG. 5 is a flow chart illustrating an actuator control method of an inkjet printing system according to an embodiment of the present general inventive concept. Referring to FIGS. 4 and 5, a waveform of predetermined magnitude is applied to the actuator 120 to drive the actuator 120 (S510). Then, an inductive voltage value induced by the deformation of the actuator 120 is detected (S520).

As described above, the inductive voltage value induced by the deformation of the actuator 120 can be calculated using the above mathematical formulas 2 and 3. These formulas use the output value from the actuator 120, which is detected by the plurality of capacitors connected in the form of the bridge.

Next, the magnitude of the waveform applied to the actuator 120, is adjusted according to the calculated inductive voltage value (S530).

To detect the displacement of the actuator 120 and adjust the magnitude of the waveform continuously the process is carried out for the period where the waveform signal is applied to the actuator 120, as well as for the period where the waveform signal is not applied to the actuator.

The present general inventive concept can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As is apparent from the foregoing description, according to the exemplary embodiments of the present general inventive concept, the inkjet printer head, the inkjet printing system, and the control method thereof control the actuator and detect the inductive voltage value induced by the deformation of the actuator, thereby allowing the displacement of the actuator to be continuously detected for the entire period including the period where the electric power, i.e., the waveform signal is applied to the actuator, and the period where the waveform signal is not applied to the actuator. Accordingly, the actuator can be controlled in real time, so that the displacements of the actuator are identical to each other and produce electric power of the same magnitude. Thus, in the inkjet printer head and the inkjet printing system, the volumes and the speeds of the ink droplets ejected through the nozzle can be identically adjusted, thereby increasing printing quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printing system comprising:
a waveform generator to supply an electric power in the form of a predetermined wave;
at least one actuator to change a pressure in an ink chamber according to the electric power from the waveform generator;
at least one sensing unit to continuously detect and output a voltage value as voltage output from the actuator; and
a controller to calculate an inductive voltage value induced by a deformation of the actuator using the voltage value of the sensing unit, and to adjust the waveform of the electric power supplied by the waveform generator according to the calculated inductive voltage value, thereby controlling the to control the actuator.

2. The system of claim 1, wherein the actuator comprises a first capacitor, and the sensing unit comprises:
a second capacitor connected to the actuator to form a circuit such that the second capacitor is connected in series with a first capacitor included within the actuator;
a third capacitor connected between the actuator and the ground such that the third capacitor is connected in parallel with the first capacitor and the second capacitor; and
a fourth capacitor connected in series between the third capacitor and the ground, to output a first node voltage between the first capacitor and the second capacitor and a second node voltage between the third capacitor and the fourth capacitor.

3. The system of claim 2, further comprising:
a calculator to calculate a difference in electric potential between the first node voltage and the second node voltage and to provide the difference to the controller.

4. The system of claim 3, wherein the controller obtains the inductive voltage value according to the difference in electric potential between the first node voltage and the second node voltage using formula 1, and formula 2.:
$$\begin{matrix}{P}^{T} q = \{ {V}_{s} - ( \frac{{C}_{p}}{{C}_{p} + {C}_{1}} - \frac{{C}_{r}}{{C}_{r} + {C}_{1}} ) {V}_{c} \} * ( {C}_{p} + {C}_{1} ) & ( 1 ) \\ {V}_{p} = \frac{{P}^{T} q}{{C}_{p}} & ( 2 )\end{matrix}$$
where Vₛ is the difference in electric potential between the first node voltage and the second node voltage, Cₚ is the first capacitance component, C₁ is a capacitance of the second and the fourth capacitors, Cᵣ is a capacitance of the third capacitor, V_{c} is a magnitude of the electric power, p^{T} is a row vector presenting a force of the actuator which is applied to the ink chamber, q is a column vector presenting the displacement of the actuator, and Vₚ is the inductive voltage value induced by the deformation of the actuator.

5. The system of claim 4, wherein the controller compares the inductive voltage value with a predetermined reference value to control the waveform generator in order to reduce a magnitude of the waveform if the inductive voltage value is larger than the predetermined reference value and to increase the magnitude of the waveform if the inductive voltage value is smaller than the predetermined reference value.

6. The system of claim 5, further comprising:
a trigger signal producing unit to produce a trigger signal to determine a driving point of time of the actuator and to provide the trigger signal to the controller;
wherein the controller drives the actuator according to the trigger signal provided from the trigger signal producing unit.

7. The system of claim 6, further comprising:
an amplifier to amplify the waveform outputted from the waveform generator and to provide the amplified waveform to the actuator.

8. The system of claim 1, wherein the actuator is formed of piezoelectric material.

9. An inkjet printer head comprising:
at least one actuator to change a pressure in an ink chamber when electric power in the form of a predetermined wave is applied; and
at least one sensing unit to continuously detect and output a voltage value for a voltage output from the actuator to control the actuator.

10. The inkjet printer head of claim 9, wherein the actuator comprises a first capacitor, and the sensing unit comprises:
a second capacitor connected to the actuator to form a circuit with the actuator such that the second capacitor is connected in series with the first capacitor included within the actuator;
a third capacitor connected between the actuator and a ground such that the that the third capacitor is connected in parallel with the first capacitor and the second capacitor; and
a fourth capacitor connected in series between the third capacitor and the ground, which outputs a first node voltage between the first capacitance component and the second capacitor and a second node voltage between the third capacitor and the fourth capacitor.

11. The inkjet printer head of claim 10, wherein a difference in electric potential between the first node voltage and the second node voltage is represented by the following formula:
$${V}_{s} = {V}_{1} - {V}_{2} = ( \frac{{C}_{p}}{{C}_{p} + {C}_{1}} - \frac{{C}_{r}}{{C}_{r} + {C}_{1}} ) {V}_{c} + \frac{{P}^{T}}{{C}_{p} + {C}_{1}} q$$
where Vₛ is the difference in electric potential, V₁ is the first node voltage, V₂ is the second node voltage, Cₚ is the first capacitance component, C₁ is a capacitance of the second and the fourth capacitors, Cᵣ is a capacitance of the third capacitor, V_{c} is a magnitude of the electric power, p^{T} is a row vector presenting a force of the actuator which is applied to the ink chamber, and q is a column vector presenting the displacement of the actuator.

12. The inkjet printer head of claim 9, wherein the actuator is formed of piezoelectric material.

13. A method of control an inkjet printing system having at least one ink chamber and at least one actuator formed of a piezoelectric material to change pressure in the ink chamber, the method comprising:
applying an electric power to the actuator to deform the actuator;
continuously detecting a voltage value as a voltage output from the actuator;
calculating an inductive voltage value induced by deformation of the actuator using the detected voltage value; and
adjusting a waveform of the electric power according to the calculated inductive voltage value to control the actuator.

14. The method of claim 13, wherein the actuator comprises a first capacitor, and the continuous detecting the voltage value comprises detecting and outputting a first node voltage and a second node voltage by using a sensing circuit comprising:
a second capacitor connected to the actuator to form a circuit in such a manner that the second capacitor is connected in series with the first capacitor;
a third capacitor connected between the actuator and a ground, such that the third capacitor is connected in parallel with the first capacitor and the second capacitor; and,
a fourth capacitor connected in series between the third capacitor and the ground such that there is a first node voltage generated between the first capacitor and the second capacitor and a second node voltage between the third capacitor and the fourth capacitor.

15. The method of claim 14, wherein the calculating the inductive voltage value comprises:
calculating the difference in electric potential between the first node voltage and the second node voltage according to formula 1 and formula 2:
$$\begin{matrix}{P}^{T} q = \{ {V}_{s} - ( \frac{{C}_{p}}{{C}_{p} + {C}_{1}} - \frac{{C}_{r}}{{C}_{r} + {C}_{1}} ) {V}_{c} \} * ( {C}_{p} + {C}_{1} ) & ( 1 ) \\ {V}_{p} = \frac{{P}^{T} q}{{C}_{p}} & ( 2 )\end{matrix}$$
where Vₛ is the difference in electric potential between the first node voltage and the second node voltage, Cₚ is the first capacitance component, C₁ is a capacitance of the second and the fourth capacitors, Cᵣ is a capacitance of the third capacitor, V_{c} is a magnitude of the electric power, p^{T} is a row vector presenting a force of the actuator which is applied to the ink chamber, q is a column vector presenting the displacement of the actuator, and Vₚ is the inductive voltage value induced by the deformation of the actuator.

16. The method of claim 15, wherein the adjusting of the waveform of the supplied electric power comprises:
comparing the inductive voltage value with a predetermined reference value;
reducing a magnitude of the waveform if the inductive voltage value is larger than the predetermined reference value; and
increasing the magnitude of the waveform if the inductive voltage value is smaller than the predetermined reference value.

17. An inkjet printing system comprising:
a waveform generator to supply an electric power;
at least one actuator to change a pressure in an ink chamber to be deformed according to the electric power;
a controller to control the actuator according to an inductive voltage value induced by a deformation of the actuator.

18. The system of claim 17, wherein the controller controls the actuator to have a uniform displacement.

19. The system of claim 17, wherein the controller controls the actuator to maintain uniform pressure in the ink chamber.

20. The system of claim 17, wherein the controller generates a second electric power according to the inductive value to control the actuator.

21. The system of claim 20, wherein the controller controls the actuator to have the same amount of the displacement of the actuator.

22. The system of claim 20, wherein the controller controls the actuator to eject the same amount of ink from the ink chamber according to the inductive voltage value.

23. The system of claim 17, wherein the controller repeats to adjust the electric power until the inductive voltage value is less than a reference.

24. The system of claim 17, further comprising:
a sensing unit to detect a voltage difference between the electric power applied to the actuator and a second electric power generated from the actuator.

25. The system of claim 17, wherein the displacement of the actuator comprises a vibration to cause a pressure change of the ink chamber.

26. A computer readable recording medium having embodied thereon a program which executes a method of determining a characteristic of an actuator to change a pressure in an ink cartridge, the method comprising:
applying an electric power to the actuator to deform the actuator;
continuously detecting a voltage value as a voltage output from the actuator;
calculating an inductive voltage value induced by deformation of the actuator using the detected voltage value; and
adjusting a waveform of the electric power according to the calculated inductive voltage value to control the actuator.
